(19) United States
(12) Patent Application Publication
(10) Pub. No.: US 2021/0395573 A1
(43) Pub. Date: Dec. 23, 2021

(54) HIGH FREQUENCY EASY MELTING MULTIPLE LAYERED STRUCTURE

(71) Applicants: CHIH YI LIN, Kaohsiung City (TW); KUO KUANG CHENG, Kaohsiung City (TW); CHIEN CHIA HUANG, Kaohsiung City (TW); CHIA HO LIN, Kaohsiung City (TW); CHIEN MIN WU, Kaohsiung City (TW); WEI CHAO WANG, Kaohsiung City (TW)

(72) Inventors: CHIH YI LIN, Kaohsiung City (TW); KUO KUANG CHENG, Kaohsiung City (TW); CHIEN CHIA HUANG, Kaohsiung City (TW); CHIA HO LIN, Kaohsiung City (TW); CHIEN MIN WU, Kaohsiung City (TW); WEI CHAO WANG, Kaohsiung City (TW)

(21) Appl. No.: 16/905,938

(22) Filed: Jun. 19, 2020

(51) Int. Cl. C09J 7/35; C09J 7/50; C09J 7/21

(52) U.S. Cl. CPC C09J 7/35; B32B 27/40; C09J 7/21; C09J 7/50

(57) ABSTRACT

The present invention is related to a high frequency easy melting multiple layered structure, which includes a high frequency easy melting coating layer; a high frequency easy melting adhesive layer installed below the high frequency easy melting coating layer and a high frequency easy melting thermoplastic polyurethane (TPU) substrate placed below the high frequency easy melting adhesive layer. They serve to reduce the energy and time period in the high frequency melting and connection so as to promote producing speed and capacity effectively.

### FIELD OF THE INVENTION

The present invention is related to multiple layered structures, and in particular to a high frequency easy melting multiple layered structure.

### BACKGROUND OF THE INVENTION

Conventionally, to combine leathers are mainly made by seaming, but this way need more time so that the production speed is prolonged, amount of production is reduced, and the cost is increased. Thereby, the way of combination by adhesion is also used.

In China patent CN105818502B, a way for combination of leathers is disclosed. In that, a net cloth layer has a first surface and a second surface. The first surface is opposite to the second surface. A first adhesive layer is on the first surface of the net cloth layer. The first adhesive layer is made of thermoplastic resin which is a PU (polyurethane) adhesive. This PU adhesive is a mixer of PU paste and thermal melting PU resin. The weight ratio of the PU paste and thermal melting PU resin is 4:1 to 1:1. The solid material in the PU paste is larger than 10 wt %. A first surface layer is on the first adhesive layer. A first high solidification layer is between the first adhesive layer and the first surface layer. The first solidification layer is formed by a first high molecular mixer which contains at least first high molecular resin. The first surface layer is formed by second high molecular mixer which contains at least one second high molecular rein. The solid material in the first high molecule resin is 70 wt % to 100 wt %. The first high molecular reins is PU resin. The solid material in the second high molecule resin is 15 wt % to 60 wt %. The second high molecular reins is PU resin, water solvable elastomer resin; or water dispersed elastomer resin which are combined by PU adhesive.

In Taiwan invention Patent 1576241, a multiple layered structure is disclosed. The multiple layered structure includes a net cloth layer which has a first surface and a second surface. The second surface is formed with respect to the second surface. The net cloth layer is a plurality of penetrating holes which penetrates from the first surface to the second surface. A first adhesive layer is on the first surface of the net cloth layer. The adhesive layer is formed by PU adhesive. A first surface layer is on the first adhesive layer. Besides, since high frequency operation has the advantages of saving labor powers, reduction of working time, and increasing production speed. In manufacturing, high frequency waves are frequently used to adhere the multiple layer structure.

However, in all above mentioned process, containing seaming, adhesion, and high frequency wave combination, the melting process is necessary which is commonly performed by high frequency waves or thermal pressing. In high frequency melting, the current is between 4 to 5 A, voltage is between 60 to 100V and the energy is between 240 to 500 W, the time necessary for melting is between 10 to 15 seconds. However, it is difficult in performing the cutting working. Time and man power are increased and thus cost is also increased.

### SUMMARY OF THE INVENTION

Accordingly, to improve above mentioned defects in the prior art, the present invention provides a high frequency easy melting multiple layered structure comprising: a high frequency easy melting coating layer; a high frequency easy melting adhesive layer installed below the high frequency easy melting coating layer; a high frequency easy melting thermoplastic polyurethane (TPU) substrate placed below the high frequency easy melting adhesive layer; wherein for the high frequency easy melting, the melting current is between 1 to 4 A, voltage is between 5 to 20V, time period for melting is between 1 to 10 seconds, and melting power is between 15 to 80 W; if all these conditions are satisfied, the coating layer and pate layer are called as high frequency easy melting.

In the present invention, the high frequency easy melting coating layer, high frequency easy melting adhesive layer and the high frequency easy melting thermoplastic polyurethane (TPU) substrate serve to reduce the energy and time period in the high frequency melting and connection so as to promote producing speed and capacity effectively.

### BRIEF DESCRIPTION OF THE DRAWINGS

FIG. 1 shows a structure of the present invention.

FIG. 2 shows a manufacturing process of the high frequency easy melting TPU substrate.

FIG. 3 shows the manufacturing process of the high frequency easy melting coating layer and high frequency easy melting adhesive layer and the adhesion of the high frequency easy melting TPU substrate.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

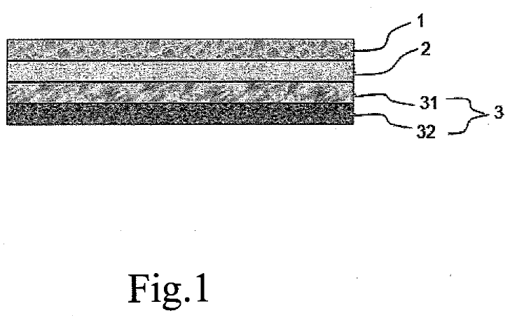

With reference to FIG. 1, the present invention includes the following layers:

A high frequency easy melting coating layer 1 is selected from PU resin, water based PU resin (PUD), water solvable elastomer resin, water dispersed elastomer resin. The ratio of solid material therein is above 10 wt %; and viscosity thereof is between 500 cps to 15000 cps.

A high frequency easy melting adhesive layer 2 is installed below the high frequency easy melting coating layer 1 and is selected from thermal melting PU resin paste, water based thermal melting PU resin paste, high frequency easy melting adhesive resin paste. The melting point of any paste is between 100° C. to 160° C., the solid material contained therein is above 15 wt %, and the viscosity is between 1000 cps to 20000 cps.

A high frequency easy melting thermoplastic polyurethane (TPU) substrate 3 is placed below the high frequency easy melting adhesive layer 2.

In the present invention, for the high frequency easy melting, the melting current is between 1 to 4 A, voltage is between 5 to 20V, time period for melting is between 1 to 10 seconds, and melting power is between 15 to 80 W. If all these conditions are satisfied, the coating layer and adhesive layer are called as high frequency easy melting.

The high frequency easy melting coating layer 1 and high frequency easy melting adhesive layer 2 serve to reduce the energy in the high frequency melting and connection and to reduce the melting and connection time period so as to promote producing speed and capacity effectively.

In one preferred embodiment of the present invention, the melting point for the resins (containing PU resin, water based PU resin (PUD), water solvable elastomer resin, water dispersed elastomer resin) used in the high frequency easy melting coating layer 1 is between 90° C. to 150° C. Furthermore no cross-linking reaction is occurred in the resin.

In one preferred embodiment of the present invention, the high frequency easy melting TPU substrate 3 has two layers. An upper layer 31 has a hardness between 70 to 90 A, the melting point thereof is between 120° C. to 150° C., the temperature range for working is between 160° C. to 220° C. The lower layer 32 thereof has a hardness between 60 to 90 A, the melting point thereof is between 90° C. to 120° C., the temperature range for working is between 140° C. to 200° C.

In one preferred embodiment of the present invention, the high frequency easy melting coating layer 1 and the high frequency easy melting adhesive layer 2 are made of coating method.

In one preferred embodiment of the present invention, color powders or color pastes can be added to the high frequency easy melting coating layer 1 with a percentage of 0.01 wt % to 30 wt % to be formed as a part of high frequency easy melting coating layer 1, and color powders or color pastes can be added to the high frequency easy melting adhesive layer 2 with a percentage of 0.01 wt % to 30 wt % to be formed as a part of the high frequency easy melting adhesive layer 2. Furthermore after adding the color powders or color pastes, the high frequency easy melting coating layer 1 and high frequency easy melting adhesive layer 2 still have the property of high frequency easy melting. Then the high frequency easy melting coating layer 1 and high frequency easy melting adhesive layer 2 are placed on the high frequency easy melting TPU substrate 3 so as to get a high frequency easy melting layered material with colors and textures.

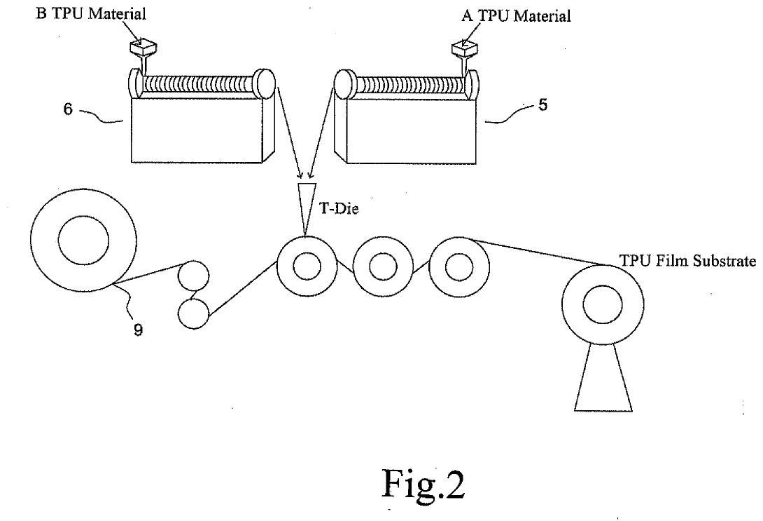

With reference to FIGS. 1 and 2, the ways for forming the high frequency easy melting TPU substrate 3 are that:

The TPU material is fed to an A extruder 5 as an upper layer 31 of the high frequency easy melting TPU substrate 3. The hardness of the material is between 70 to 90 A, and the melting point thereof is between 120° C. to 150° C., the temperature range for working is between 160° C. to 220° C.

Then TPU material is added to a B extruder 6 to be a lower layer 32 of the high frequency easy melting TPU substrate 3. The TPU has a hardness between 60 A to 90 A, the melting temperature thereof is between 90° C. to 120° C., the temperature range for working is between 140° C. to 200° C.

Then the upper layer 31 and the lower layer 32 are placed on a carrier 9 by the way of T-DIE for forming films thereon. Furthermore the output of a quantity adjusting pump is adjusted. So that the width ratio of axes of A and B pressing machines are between 4:1 to 1:4. Then the high frequency easy melting TPU substrate 3 with a width between 0.05 mm˜1.5 mm is acquired. Preferably, the width of upper layer 31 is between 0.2 mm˜0.8 mm, and the density thereof is ranged from 1.0 g/cm³ to 1.4 g/cm³, and the width of lower layer 32 is between 0.1 mm˜0.2 mm, and the density thereof is ranged from 1.0 g/cm³ to 1.4 g/cm³.

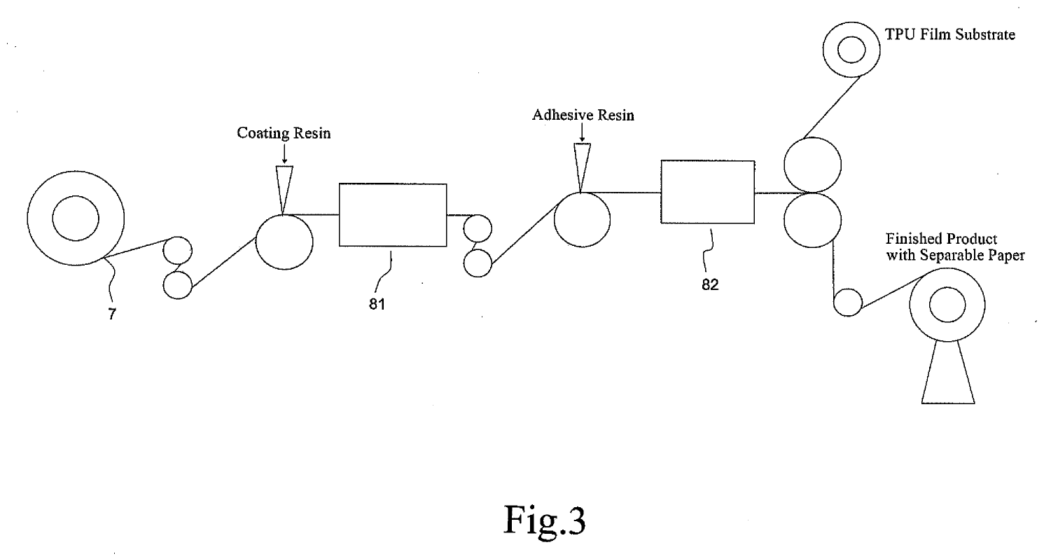

The ways of forming the high frequency easy melting coating layer 1 and high frequency easy melting adhesive layer 2 and the way for adhesion of the high frequency easy melting TPU substrate 3 will be described herein with reference to FIGS. 1 and 3.

A high frequency easy melting PU (polyurethane) resin is coated on a separable paper 7 and then it is baked by dryer 81 so as to form the high frequency easy melting coating layer 1. In this process, color powders or color pastes are properly added thereto so as to have plentiful color and textures.

Furthermore the high frequency easy melting coating layer 1 may be PU resin, water based PU resin, water solvable elastomer rein, water dispersed elastomer rein. The solid material in the high frequency easy melting coating resin is above 10 wt %, the viscosity thereof is between 500 cps to 15000 cps, the amount of added color powders or color pastes is between 0.01% to 30%. Preferably, the solid material in the high frequency easy melting coating layer 1 is between 20 wt % to 40 wt %; preferably, the viscosity is between 700 cps to 3000 cps. Preferably, the color powders or color pastes are between 0.1% to 10%. When the high frequency easy melting coating layer 1 is PU resin, the coating amount is 110 g/m2. Then under the temperature of 60° C. to 140° C., the high frequency easy melting coating resin is dried for 4 minutes so as to form a solidified coating layer. Please keep attention, if necessary, the high frequency easy melting coating resin is coated at least one time.

Then the high frequency easy melting adhesive layer 2 is coated on the high frequency easy melting coating layer 1 and then they are placed into a dryer 82 to be prebaked.

To describe more detail, the high frequency easy melting adhesive layer 2 is thermal melting PU paste, water based thermal melting PU resin paste. The melting point of high frequency easy melting adhesive resin paste is between 100° C. to 160° C. The solid material therein is above 15 wt %. The viscosity thereof is between 1000 cps to 20000 cps. The color powders or color pastes therein are between 0.01% to 30%. Preferably, the melting point is between 110° C. to 125° C. Preferably, the solid material there is between 25 wt % to 50 wt %. Preferably, the viscosity is between 3000 cps to 12000 cps. Preferably, the color powders or color pastes therein are between 0.1% to 10%. In this embodiment, the high frequency easy melting adhesive layer 2 is made of thermal melting PU resin paste.

Then they are adhered to the high frequency easy melting thermoplastic polyurethane (TPU) substrate 3. They are further curled and placed into the aging chamber so as to age. Temperature range of the aging chamber is between 30° C. to 90° C. Preferably, it is between 60° C. to 80° C. Then after drying, it is separated from the separable paper so as to get a high frequency easy melting multiple layered structure with plentiful colors and textures.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A high frequency easy melting multiple layered structure comprising:
a high frequency easy melting coating layer;
a high frequency easy melting adhesive layer installed below the high frequency easy melting coating layer; and
a high frequency easy melting thermoplastic polyurethane (TPU) substrate placed below the high frequency easy melting adhesive layer.

2. The high frequency easy melting multiple layered structure as claimed in claim 1, wherein for the high frequency easy melting, the melting current is between 1 to 4 A, voltage is between 5 to 20V, time period for melting is between 1 second to 10 seconds, and melting power is between 15 to 80 W; if all these conditions are satisfied, the high frequency easy melting coating layer and the high frequency easy melting adhesive layer are called as high frequency easy melting.

3. The high frequency easy melting multiple layered structure as claimed in claim 1, wherein the high frequency easy melting coating layer is selected from PU resin, water based PU resin (PUD), water solvable elastomer resin, water dispersed elastomer resin.

4. The high frequency easy melting multiple layered structure as claimed in claim 1, wherein a melting point for the resins (containing PU resin, water based PU resin (PUD), water solvable elastomer resin, water dispersed elastomer resin) used in the high frequency easy melting coating layer is between 90° C. to 150° C.; and no cross-linking reaction is occurred in the resin.

5. The high frequency easy melting multiple layered structure as claimed in claim 1, wherein the high frequency easy melting adhesive layer is selected from thermal melting PU resin paste, water based thermal melting PU resin paste, high frequency easy melting adhesive resin paste; a melting point of any paste is between 100° C. to 160° C.

6. The high frequency easy melting multiple layered structure as claimed in claim 1, wherein the high frequency easy melting TPU substrate has two layers; an upper layer has a hardness between 70 A to 90 A, the melting point thereof is between 120° C. to 150° C., and the density thereof is ranged from 1.0 g/cm³ to 1.4 g/cm³; a lower layer thereof has a hardness between 60 A to 90 A, the melting point thereof is between 90° C. to 120° C., and the density thereof is ranged from 1.0 g/cm³ to 1.4 g/cm³.

7. The high frequency easy melting multiple layered structure as claimed in claim 1, wherein color powers or color pastes are added to the high frequency easy melting coating layer with a percentage of 0.01 wt % to 30 wt % to be formed as a part of high frequency easy melting coating layer, and color powders or color pastes are added to the high frequency easy melting adhesive layer with a percentage of 0.01 wt % to 30 wt % to be formed as a part of the high frequency easy melting adhesive layer; after adding the color powders or color pastes, the high frequency easy melting coating layer and high frequency easy melting adhesive layer still has the property of high frequency easy melting.
